(19) United States
(12) Patent Application Publication
(10) Pub. No.: US 2011/0074970 A1
(43) Pub. Date: Mar. 31, 2011

(54) IMAGE PROCESSING APPARATUS AND IMAGE PROCESSING METHOD

(75) Inventor: Hiroshi Sukegawa, Yokohama-shi (JP)

(73) Assignee: KABUSHIKI KAISHA TOSHIBA, Tokyo (JP)

(21) Appl. No.: 12/883,973

(22) Filed: Sep. 16, 2010

(30) Foreign Application Priority Data
Sep. 28, 2009 (JP) 2009-223223

(51) Int. Cl. H04N 5/228; G06K 9/46

(52) U.S. Cl. 348/222.1; 382/190; 348/E05.031

(57) ABSTRACT

According to one embodiment, an image processing apparatus comprises a plurality of image input modules configured to input images, a detection module configured to detect object regions from an image input by any image input module, a feature extracting module configured to extract feature values from any object regions detected by the detecting module, and a control module configured to control processes the detection module and feature extracting module perform on the images input by the plurality of image input modules, in accordance with the result of detection performed by the detection module.

### CROSS-REFERENCE TO RELATED APPLICATIONS

This application is based upon and claims the benefit of priority from Japanese Patent Application No. 2009-223223, filed Sep. 28, 2009; the entire contents of which are incorporated herein by reference.

### FIELD

Embodiments described herein relate generally to an image processing apparatus and an image processing method, both designed to photograph images and calculate feature values of each image photographed.

### BACKGROUND

Monitoring systems have been put to general use, each using a plurality of cameras located at a plurality of positions and monitoring, in unity, the data items the cameras has acquired. To enable watchmen to perform more reliable monitoring, techniques of displaying images containing human figures have been developed.

An image processing apparatus sets beforehand, for example, a method of determining the priority for images input from a plurality of cameras. The image processing apparatus determines the priority of each image with respect to any other image, in accordance with the priority determining method set to it. In accordance the priority determined, the image processing apparatus performs various processes, such as “switching the display to display the image better,” “changing the transmission frame rate and/or encoding method,” “selecting an image to transmit and a camera to use,” “changing the priority of video recording,” and “performing PTZ control on the camera.”

For example, Jpn. Pat. Appln. KOKAI Publication No. 2005-347942, which is a Japanese patent document, describes an image processing apparatus that can switch the camera-monitoring location, image quality, recording on/off, recorded-image quality, monitor display on/off, monitor-displayed image size, monitoring mode on/off and counting mode on/off, for a plurality of monitor cameras, in accordance with the number of specified objects counted. This image processing apparatus displays the images the monitor cameras has photographed, to a watchman, and efficiently transmits, displays and records any image the watchman has visually confirmed.

Further, Jpn. Pat. Appln. KOKAI Publication No. 2007-156541, for example, which is also a Japanese patent document, describes an image processing system that processes any image monitored and then automatically detect a specific event from the image. If the image photographed by a camera shows a plurality of persons, this image processing system determines the processing load that can be spent to process the image, from various data items representing the walking speed of any person monitored, number of the passengers seen in the image, distances between the passengers and the time elapsed from the start of collation. In accordance with the processing load thus determined, the image processing system controls the process precision and the data about any person monitored.

The method described in Jpn. Pat. Appln. KOKAI Publication No. 2005-347942 is designed to control the image to display to watchmen. The method, however, is not so configured to monitor any person by means of automatic recognition. Further, the method may fail to recognize persons as fast as desired, depending on the image contents, if the cameras are connected to image processing apparatuses fewer than the cameras used. It is therefore necessary to use high-performance image processing apparatuses or more image processing apparatuses than the cameras. Consequently, the system will be expensive and the apparatuses will occupy a large installation space.

The method described in Jpn. Pat. Appln. KOKAI Publication No. 2007-156541 is designed to process one image at high efficiency, not designed to process images photographed by a plurality of cameras. Hence, this method cannot monitor, in unity, the images a plurality of cameras have photographed.

### BRIEF DESCRIPTION OF THE DRAWINGS

FIG. 1 is a block diagram explaining an exemplary configuration of an image processing apparatus according to a first embodiment;

FIG. 2A is a diagram explaining an exemplary image photographed by one of the cameras shown in FIG. 1;

FIG. 2B is a diagram explaining another exemplary image photographed by one of the cameras shown in FIG. 1;

FIG. 2C is a diagram explaining still another exemplary image photographed by one of the cameras shown in FIG. 1;

FIG. 2D is a diagram explaining a further exemplary image photographed by one of the cameras shown in FIG. 1;

FIG. 3A is a diagram explaining a face detecting process performed on an image photographed by one of the cameras shown in FIG. 1;

FIG. 3B is another diagram explaining the face detecting process performed on an image photographed by one of the cameras shown in FIG. 1;

FIG. 3C is still another diagram explaining the face detecting process performed on an image photographed by one of the cameras shown in FIG. 1;

FIG. 4A is a diagram explaining a face detecting process performed on an image photographed by one of the cameras shown in FIG. 1;

FIG. 4B is a diagram explaining another face detecting process performed on an image photographed by one of the cameras shown in FIG. 1;

FIG. 4C is a diagram explaining still another face detecting process performed on an image photographed by one of the cameras shown in FIG. 1;

FIG. 5A is a diagram explaining an exemplary face detecting process performed on an image photographed by one of the cameras shown in FIG. 1;

FIG. 5B is a diagram explaining another exemplary face detecting process performed on an image photographed by one of the cameras shown in FIG. 1;

FIG. 5C is a diagram explaining still another exemplary face detecting process performed on an image photographed by one of the cameras shown in FIG. 1;

FIG. 6 is a block diagram explaining an exemplary configuration of an image processing apparatus according to a second embodiment; and

FIG. 7 is a diagram explaining an exemplary face detecting process performed on the images photographed by the cameras shown in FIG. 6.

### DETAILED DESCRIPTION

In general, according to one embodiment, an image processing apparatus comprises: a plurality of image input modules configured to input images; a detection module configured to detect object regions from an image input by any image input module; a feature extracting module configured to extract feature values from any object regions detected by the detecting module; and a control module configured to control processes the detection module and feature extracting module perform on the images input by the plurality of image input modules, in accordance with the result of detection performed by the detection module.

An image processing apparatus according to a first embodiment will be described in detail, with reference to the accompanying drawings.

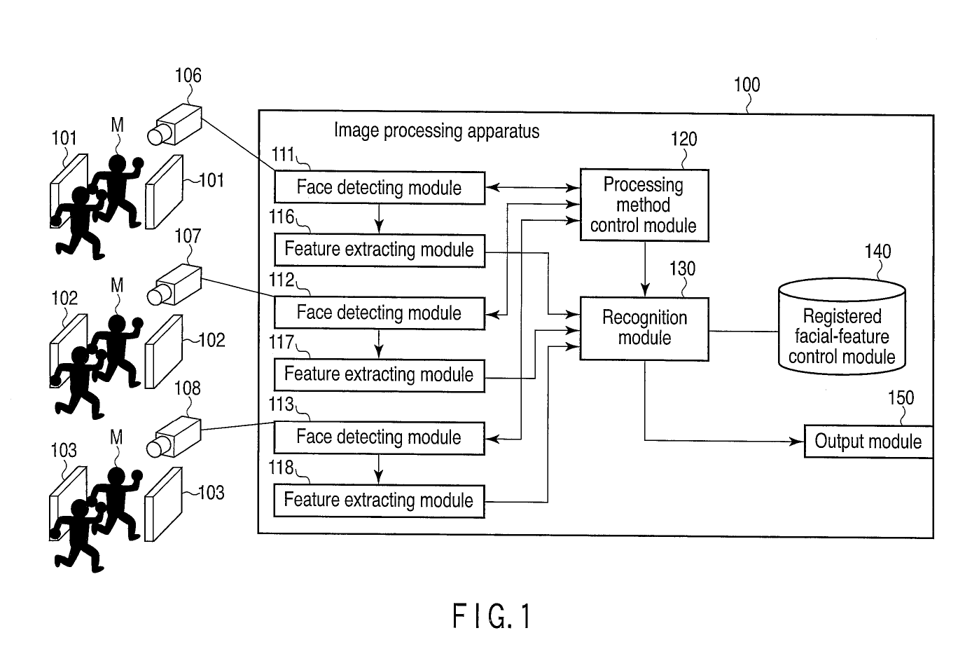

FIG. 1 is a block diagram explaining an exemplary configuration of an image processing apparatus 100 according to the first embodiment.

Assume that the image processing apparatus 100 is incorporated in, for example, a passage control system that controls the passage of people and installed at a location where only specific persons can pass, such as the entrance to a building (e.g., company building) or the gate to an amusement or traffic facility.

Also assume that the image processing apparatus 100 is configured to collate the feature data acquired from a face image of a person with the feature data items registered beforehand, thereby to determine whether at least one person exists, whose features are identical to the feature data items registered.

As shown in FIG. 1, the image processing apparatus 100 comprises face detecting modules 111, 112 and 113 (generally called “face detecting module 114”), feature extracting modules 116, 117 and 118 (generally called “feature extracting module 119”), a processing method control module 120, a recognition module 130, a registered facial-feature control (storage) module 140, and an output module 150.

Further, a camera 106 is installed in passage 101. A camera 107 is installed in passage 102. A camera 108 is installed in passage 103. In generally, the cameras 106, 107 and 108 called “camera 109”. The camera 106 is connected to the face detecting modules 111. The camera 107 is connected to the face detecting modules 112. The camera 108 is connected to the face detecting modules 113. Note the number of cameras connected to the face detecting module 114 is not limited to three.

The camera 109 function as image input module. The camera 109 is constituted by, for example, an industrial television (ITV) camera. The camera 109 scans a prescribed area, generating a moving image (i.e., a number of consecutive images of objects existing in the area). Thus, the camera 109 generates images, each containing the face of any passenger walking in the area. The camera 109 has an analog-to-digital (A/D) converter, which converts the images to digital video data items. The digital video data items are sequentially transmitted from the camera 109 to the face detecting module 114. The camera may include a mean for measuring the walking speed of each passenger.

The face detecting module 114 detects faces from the any input image. The feature extracting module 119 extracts feature data from each face image the face detecting module 114 has detected.

The processing method control module 120 controls the method of recognizing any person and the method of detecting the face of that person in the face detecting module 114, in accordance with the results of various processes performed on the input image. The processing method control module 120 functions as control module.

The registered facial-feature control module 140 registers and controls the facial feature of any person to recognize. The recognition module 130 compares the facial feature of Passenger M, which the feature extracting module 119 has extracted from the image of Passenger M, with the facial features registered in the registered facial-feature control module 140, thereby determining who Passenger M is.

The registered facial-feature control module 140 stores, as registered data, the facial feature data items about persons, each item associated with the ID data about one person, which is used as a key. That is, the registered facial-feature control module 140 stores ID data items in association with the facial feature data items, respectively. Note that in the registered facial-feature control module 140, one facial feature data item may be associated with a plurality of facial feature data items. In order to recognize a person on the basis of an image photographed, the image processing apparatus 100 may use a plurality of facial feature data items. Moreover, the registered facial-feature control module 140 may be provided outside the image processing apparatus 100.

The output module 150 receives the result of recognition from the recognition module 130 and outputs the result of recognition. In accordance with the result of recognition, the output module 150 further outputs control signals, audio data and video data to external devices connected to the image processing apparatus 100.

The face detecting module 114 detects any region (face region) in the image input from the camera 109, in which the face of a person exists. More precisely, the face detecting module 114 detects, from the input image, the image of the face (face image) of Passenger M walking in the area the camera 109 is scanning, and also the position the face image takes in the input image.

The face detecting module 114 detects the face region of the input image, by moving a template in the input image, thereby obtaining a correlation value. In this embodiment, the face detecting module 114 detects, as face region, the reposition where the largest correlation value is calculated.

Various methods of detecting the face region are available. The image processing apparatus 100 according to this embodiment may use, for example, the eigen space method or the subspace method, to detect the face region from the input image.

The image processing apparatus 100 can detect facial parts, such as the eyes, nose and mouth, from the face region detected. To detect the facial parts, the apparatus 100 may perform the methods disclosed in, for example, Kazuhiro Fukui and Osamu Yamaguchi, “Extraction of Facial Feature by Using Shape Extraction and Pattern Collation,” Electronics, Information and Communication Engineers, Journal (D), Vol. J80-D-II, No. 8, pp. 2170-2177, 1997 (hereinafter referred to as “Document 1,”) and Mayumi Yuasa and Akiko Nakajima, “Digital Make System Based on High-Precision Detection of Facial Feature,” Proceedings, 10th Symposium of Image Sensing, pp. 219-224, 2004 (hereinafter referred to as “Document 2.”)

This embodiment will be explained on the assumption that it is configured to authenticate any person by using his or her face image. Nonetheless, the eye image may be used instead to recognize the person. More precisely, an image of the entire eye, an image of the iris or an image of the retina may be use. In this case, the image processing apparatus 100 detects the eye region of the face image, and the camera is zoomed in to acquire an enlarged image of the eyes.

The image processing apparatus 100 generates video data representing an image defined by pixels arranged in a two-dimensional matrix pattern, no matter whether the image pertains to the eye, the iris or the retina.

In order to extract one face from a input image, the image processing apparatus 100 obtains the correlation value the input image has with respect to the template, and detects, as face region, the position and the size at which the correlation value is the largest.

In order to extract a plurality of faces from one input image, the image processing apparatus 100 first obtains the largest correlation value in the image and then selects some of the face candidates in consideration of the mutual overlapping of the faces in the image. Further, the image processing apparatus 100 detects a plurality of face regions simultaneously, in consideration of the relation the image has with some consecutive images input before (i.e., change the image has changed with time).

As described above, the image processing apparatus 100 according to this embodiment detects face regions of people. Instead, the image processing apparatus 100 may detect, man regions existing in the input image. The image processing apparatus 100 can detect man regions if it utilizes the technique disclosed in, for example, Nobuto Matsuhira, Hideki Ogawa and Taku Yoshimi, “Life-Assisting Robot for People,” Toshiba Review, Vol. 60, No. 7, pp. 112-115, 2005 (hereinafter referred to as “Document 3.”)

The camera 109 generates images one after another, and transmits image data, frame by frame, to the face detecting module 114. The face detecting module 114 detects a face region in each image input to it.

From the data detected here, data items can be extracted, which represent the position (coordinate) of the face of each Passenger M, the sizes thereof, the moving speeds thereof and the number of the faces found.

The face detecting module 114 can calculate the difference between the frames of the entire image, thereby to find the number of pixels which represent a moving region of the entire image (or the area of the moving region). That region of the input image, which is adjacent to the changing region, is processed prior to any other region, whereby any face region can be detected at high speed. Moreover, the face detecting module 114 can infer the physical value of anything other than man based on the number of pixels which represent a moving region of the entire.

The face detecting module 114 extracts a region of the image, in the size based on the position of the face region detected or the positions of the facial parts detected. More precisely, the face detecting module 114 extracts a face region defined by, for example, m pixels×n pixels, from the input image. The face detecting module 114 transmits the image, so extracted, to the feature extracting module 119.

The feature extracting module 119 extracts the grayscale data about the image extracted, as feature value. In this instance, the grayscale values of the m×n pixels, which form a two-dimensional image, is used as a feature vector. The recognition module 130 calculates the similarity between these pixels by the simple similarity method. That is, the recognition module 130 performs the simple similarity method, thereby setting the vector and its length to value “1.” The recognition module 130 further calculates the inner product, thereby finding the similarity between a plurality of feature vectors. If the camera 109 has acquired only one image, the feature of the image can be extracted by performing the process described above.

In order to output the result of recognition, a moving image composed of a plurality of consecutive images may be used. If this is the case, the image processing apparatus 100 can recognize persons at higher precision than otherwise. In view of this, this embodiment performs a recognition method using a moving image, as will be explained below.

To recognize a person by using a moving image, the camera 109 photographs a region continuously. The face detecting module 114 extracts face region images (m×n pixel images) from these consecutive images. The recognition module 130 acquires a feature vector for each of the face region images extracted, thereby obtaining a correlation matrix from the feature vector acquired for each face region image.

The recognition module 130 acquires a normalized orthogonal vector from the correlation matrix of feature vectors by means of, for example, Karhunen-Loeve expansion (KL expansion). The recognition module 130 can therefore calculate the subspaces representing the facial features appearing in the consecutive images and can thereby recognize the facial features.

In order to calculate a subspace, the recognition module 130 first obtains a correlation matrix (or covariance matrix) of feature vectors. Then, the recognition module 130 performs KL expansion on the correlation matrix of feature vectors, obtaining the normalized orthogonal vectors (i.e., eigen vectors). The recognition module 130 thereby calculates a subspace.

The recognition module 130 selects k eigen vectors corresponding to eigen values and being larger than any other eigen vectors. The recognition module 130 uses the k eigen vectors selected, which represent a subspace.

In the present embodiment, the recognition module 130 obtains a correlation matrix of Cd=φdΔdφdT. The recognition module 130 renders the correlation matrix (Cd=φdΔdφdT) diagonal, thereby obtaining the matrix φd of the eigen vectors. The data representing this matrix φd is a subspace that represents the facial feature of the person to recognize.

The registered facial-feature control module 140 stores the subspace thus calculated, as registered data. The feature data items stored in the registered facial-feature control module 140 are feature vectors of, for example, m×n pixels. Alternatively, the registered facial-feature control module 140 may store the face image from which no features have yet to be extracted. Still alternatively, the feature data items stored in the registered facial-feature control module 140 may be the data representing the subspace or the correlation matrix not subjected to KL expansion yet.

The facial feature data items may be held in the registered facial-feature control module 140, in any number, so long as at least one item for each person. That is, while the registered facial-feature control module 140 is storing a plurality of facial feature data items for each person, the facial feature data item can be switched from one to another to recognize the person, as needed in accordance with the monitoring state.

As another feature extracting method, a method is available, which obtains feature data from one face image. This method can extract face feature data. See, for example, Elky Oya, Hidemitsu Ogawa and Makoto Satoh, “Pattern Recognition and Subspace Method,” Sangyo Tosho, 1986 (hereinafter referred to as “Document 4”), and Tatsuo Kozakatani, Toshiba, “Apparatus, Method and Program for Recognizing Images,” Jpn. Pat. Appln. KOKAI Publication No. 2007-4767 (hereinafter referred to as “Document 5.”)

Document 4 describes a method of recognizing a person by projecting an image to a subspace represented by registered data prepared from a plurality of face images by means of the subspace method. If the method described in Document 4 is performed, the recognition module 130 can use one image to recognize the person.

Document 5 describes a method of generating an image (disturbed image) in which the orientation, state, etc. of the face have been intentionally changed. The disturbed image, which shows the changed orientation, state, etc. of the face, may be used to recognize the person.

The recognition module 130 compares the input subspace acquired by the feature extracting module 119 with one or more subspaces registered in the registered facial-feature control module 140, in terms of similarity. The recognition module 130 can therefore determine whether the image of a registered person exists in the input image.

The recognition process can be achieved by using the mutual subspace method disclosed in, for example, Kenichi Maeda and Sadakazu Watanabe, “Pattern Matching Method Using a Local Structure,” Electronics, Information and Communication Engineers, Japan, Journal (D), Vol. J68-DI, No. 3, pp. 345-352, 1985 (hereinafter referred to as “Document 6.”)

In this method, the recognized data contained in the registered data and the input data are expressed as subspaces. That is, in the mutual subspace method, the facial feature data stored in the registered facial-feature control module 140 and the feature data generated from the image photographed by the camera 109 are designated as subspaces. These two subspaces define an angle, which is calculated as similarity.

Herein, the subspaces calculated from the input image shall be called “input subspaces.” The recognition module 130 obtains a correlation matrix, “Cin=φinΔinφinT” from an input data train (i.e., images photographed by the camera 109).

The recognition module 130 then renders the correlation matrix (Cin=φinΔinφinT) diagonal, thereby obtaining an eigen vector φin. The recognition module 130 calculates the similarity between the subspace designated by vector φin and the subspace designated by vector φd. In other words, the recognition module 130 finds the similarity (0.0 to 1.0) between these two subspaces.

If a plurality of face regions exist in the input image, the recognition module 130 performs the recognition process on each face region. That is, the recognition module 130 calculates the similarity between any feature data item held in the registered facial-feature control module 140 and the image in the face region. The recognition module 130 can thereby obtain the result of the recognition process. For example, X persons may walk toward the image processing apparatus 100 that stores a dictionary about Y persons. In this case, the recognition module 130 calculates similarity X×Y times, accomplishing the recognition process. The recognition module 130 can therefore output the result of recognizing all X persons.

None of the input images may be found identical to any of the data item held in the registered facial-feature control module 140. That is, the recognition module 130 may not output any result of recognition. The recognition module 130 then performs the recognition process again, on the basis of the image the camera 109 has photographed next (i.e., image of the next frame).

In this case, the recognition module 130 adds the correlation matrix for one frame to the sum of the correlation matrices for the frames input in the past. The recognition module 130 calculates the eigen vector, thereby generating a subspace again. Thus, the recognition module 130 updates the subspace for the input image.

To collate the consecutive face images of a walking person, the recognition module 130 updates subspaces one after another. That is, the recognition module 130 performs the recognition process every time an image is input to it. The collation precision therefore gradually increases in proportion of the number of images input.

If a plurality of cameras are connected to the image processing apparatus 100 as shown in FIG. 1, the processing load in the image processing apparatus 100 will readily increase. If many passengers are detected in the image, the face detecting module 114 will extract the feature values of as many face regions detected. Moreover, the recognition module 130 performs the recognition process in accordance with the feature values thus extracted.

To prevent a delay that may occur in the feature extraction process and the recognition process, these processes must be performed at high speed. Further, if a few passengers are detected in the image, the face detecting module 114 needs to perform a process at low speed but at high precision.

The processing method control module 120 controls the recognition process and the face detecting process performed by the face detecting module 114, in accordance with the results of the various processes performed on the input image.

Since a plurality of cameras are connected to the image processing apparatus 100, the time allocated to the CPU for processing the image input from each camera must be controlled in accordance with the load of processing the image input. That is, the processing method control module 120 lengthens the time allocated to the CPU, in proportion to the load of processing the input image.

The processing method control module 120 sets processing priority to each input image, on the basis of at least one of data items such as the positions (coordinate), sizes and moving speeds, number of the face regions detected in the image input from the camera 109, and the number of moving pixels detected in the input image.

First, the processing method control module 120 counts the number N of face regions detected in each input image. Here, it is assumed that the processing method control module 120 sets higher priority to an image in which many face regions have been detected than to an image in which no face regions have been detected. The processing method control module 120 allocates to each input image, for example, a priority proportional to the number of face regions detected in the image.

Further, the processing method control module 120 determines position L1 of any face region. The processing method control module 120 infers whether a face will soon disappear from the image or not, from the view angle set to the camera 109. If a camera is positioned higher than persons like a monitor camera and if the image of a person moves toward the camera in the image input from the camera, the Y ordinate will increase in the face region. The processing method control module 120 therefore infers that the time the image of person remains in the image is short in proportion to the value of the Y ordinate, and increases the priority set to the image.

Moreover, the processing method control module 120 infers that the time the image of person remains in the image is short if the face region assumes zero position or the maximum position on the X axis. The processing method control module 120 sets high priority to an image in which a face region exists at a position near either end of the X axis. If a distance sensor is used as input mans, the priority may be set in accordance with the distance the sensor has detected.

The processing method control module 120 determines the moving speed V of any person, too. That is, the processing method control module 120 calculates the moving speed of the person from the change in the position of the face region in a frame of image and the position of the face region in the next frame of the image. The processing method control module 120 sets higher priority to an image in which the face region moves at high speed than to an image in which the face region moves at low speed.

Further, the processing method control module 120 determines classifications of persons appearing in the face regions from feature values of the face regions detected. The processing method control module 120 sets the priority in accordance with the classifications so determined.

The processing method control module 120 sets the type (classification) P of any person whose face region has been detected. The type P is, for example, the sex, age, height or garment of the person. In accordance with type P thus set, the processing method control module 120 sets priority to the image.

The processing method control module 120 determines the sex and age of the person from the similarity to the facial feature data. Further, the processing method control module 120 refers to a dictionary which has been prepared based on the data items about male and female facial features recorded and the facial data items pertaining to various age brackets. Thus, the processing method control module 120 determines whether the person appearing in the face region of the input image is male or female or to which age bracket the person belongs.

The processing method control module 120 calculates the size of the region in which any image of a person moves, from the difference between any adjacent frames, and can determine the height of the person from the height of the region and coordinate of the face image of the person. Further, the processing method control module 120 classifies the garment of the person on the basis of the image data about the region of the entire person, determining whether the person is dressed in “black,” “white” or the like, from the histogram of luminance data.

Furthermore, the processing method control module 120 determines the size “S” of any region changing in the image. More precisely, the processing method control module 120 first finds the difference between any two adjacent frames, and then performs a labeling process on the region having the difference. The processing method control module 120 can therefore determines the size of the object moving in the entire image.

If the person is moving in the image, the processing method control module 120 regards the entire region of the person as a changing region. If a car or a tree is moving in the image, the processing method control module 120 regards the car or tree as a changing region. Many regions may be moving in the image. In this case, the processing method control module 120 determines that an event will probably take place, and sets high priority.

Moreover, the processing method control module 120 determines the position “L2” of the changing region in the image. To be more specific, the processing method control module 120 determines the position of the changing region, from the size of the changing region, the difference between the frames and the gravity center of the changing region, which has been determined in the labeling process. Thus, the shorter the time in which the changing region disappear, the higher the priority the processing method control module 120 will set.

The processing method control module 120 sets priority to the image input from each of the cameras 106, 107 and 108, in accordance with the number “N” of face regions detected, the position “L1” of each face region detected, the moving speed “V” of any person detected, the type “P” of the person, the size “S” of the changing region and the position “L2” of the changing region, all determined by the methods described above.

The processing method control module 120 sets, to each input image, such priority as expressed by the following equation:

Priority=K1×N+K2×L1+K3×v+K4×P+K5×S+K6×L2 (1)

where K1 to K6 are counts that weight the values N, L1, V, P, S and L2, respectively. The higher this priority, the higher will be the speed with which to process data.

How the process is controlled in accordance with the priority will be explained below.

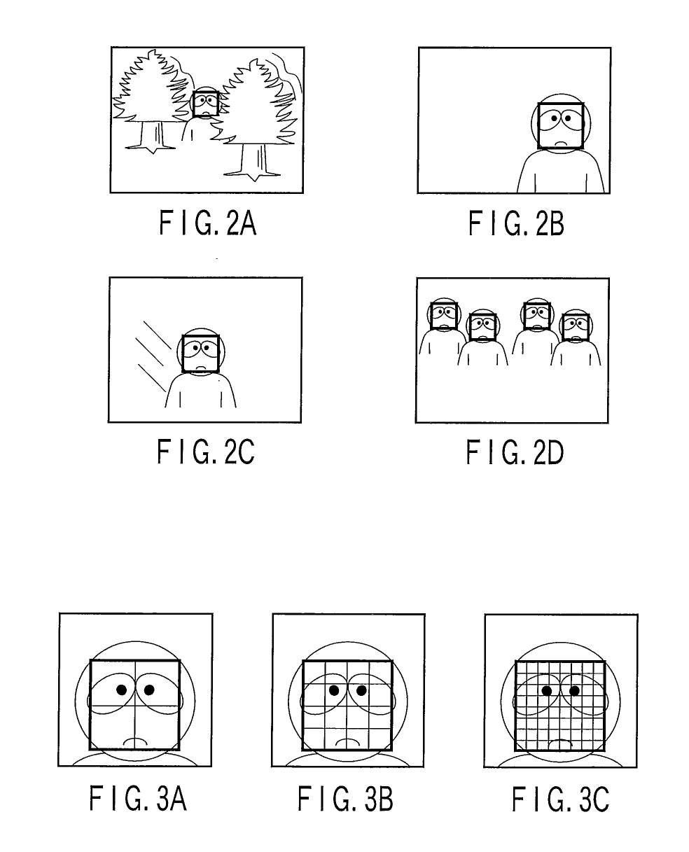

FIGS. 2A, 2B, 2C and 2D are diagrams explaining various images that may be input from the camera 109. More precisely, FIG. 2A shows an image that greatly changes, FIG. 2B shows an image in which the face region is near the camera 109, FIG. 2C shows an image in which the face region moves at high speed, and FIG. 2D shows an image that has many face regions.

The processing method control module 120 calculates priority for the image input from each camera 109, by using the equation (1). Then, the processing method control module 120 compares the priorities calculated for the images, thereby determining which image should be processed prior to any others.

The images shown in FIGS. 2A, 2B, 2C and 2D, for example, may be input at the same time to the processing method control module 120. In this case, the processing method control module 120 calculates priorities for the four images, respectively.

To raise the priority for a case where the number N of face regions detected is large, the processing method control module 120 sets K1 to the largest value. In this case, the processing method control module 120 determines that the image of FIG. 2D should be processed prior to any other images. That is, the processing method control module 120 processes the other images of FIG. 2A, FIG. 2B and FIG. 2C at the same priority.

To raise the priority for an image in which a face region moves at speed V higher than in any other images, the processing method control module 120 sets K3 to the largest value. In this case, the processing method control module 120 determines that the image of FIG. 2C should be processed prior to any other images. That is, the processing method control module 120 processes the other images of FIG. 2A, FIG. 2B and FIG. 2D at the same priority.

If the position L1 of the face region is considered most important, the processing method control module 120 sets K2 to the largest value. In this case, the processing method control module 120 determines that the image of FIG. 2B should be processed prior to any other images. That is, the processing method control module 120 processes the other images of FIG. 2A, FIG. 2C and FIG. 2D at the same priority.

If the changing region S in the image is considered most important, the processing method control module 120 sets K5 to the largest value. In this case, the processing method control module 120 determines that the image of FIG. 2A should be processed prior to any other images. That is, the processing method control module 120 processes the other images of FIG. 2B, FIG. 2C and FIG. 2D at the same priority.

Moreover, the processing method control module 120 may be configured to perform the above-described methods in combination, thereby to calculate priority for each image input to it. If this is the case, it can set the priority for any one of the images shown in FIGS. 2A to 2D, in accordance with various factors.

The processing method control module 120 controls the process of detecting a face in the input image, in accordance with the priority determined. To detect a face, the face detecting module 114 sets the resolution at which to extract a face region from the image.

FIGS. 3A, 3B and 3C are diagrams explaining how a face detecting process is performed to extract a face region from an input image. To be more specific, FIG. 3A is a diagram explaining how to extract a face region at low resolution, FIG. 3B is a diagram explaining how to extract a face region at intermediate resolution, and FIG. 3C is a diagram explaining how to extract a face region at high resolution.

In order to extract a face region from, for example, an image for which high priority has been calculated, the processing method control module 120 controls the face detecting module 114, causing the same to extract the image at low resolution as is shown in FIG. 3A.

In order to extract a face region from an image for which intermediate priority has been calculated, the processing method control module 120 controls the face detecting module 114, causing the same to extract the image at intermediate resolution as is shown in FIG. 3B.

In order to extract a face region from an image for which low priority has been calculated, the processing method control module 120 controls the face detecting module 114, causing the same to extract the image at high resolution as is shown in FIG. 3C.

To calculate feature values for the respective face regions, the face detecting module 114 designates the face regions on which to perform the face detecting process. In this case, the processing method control module 120 controls the number of face regions to extract from the image, in accordance with the priority determined.

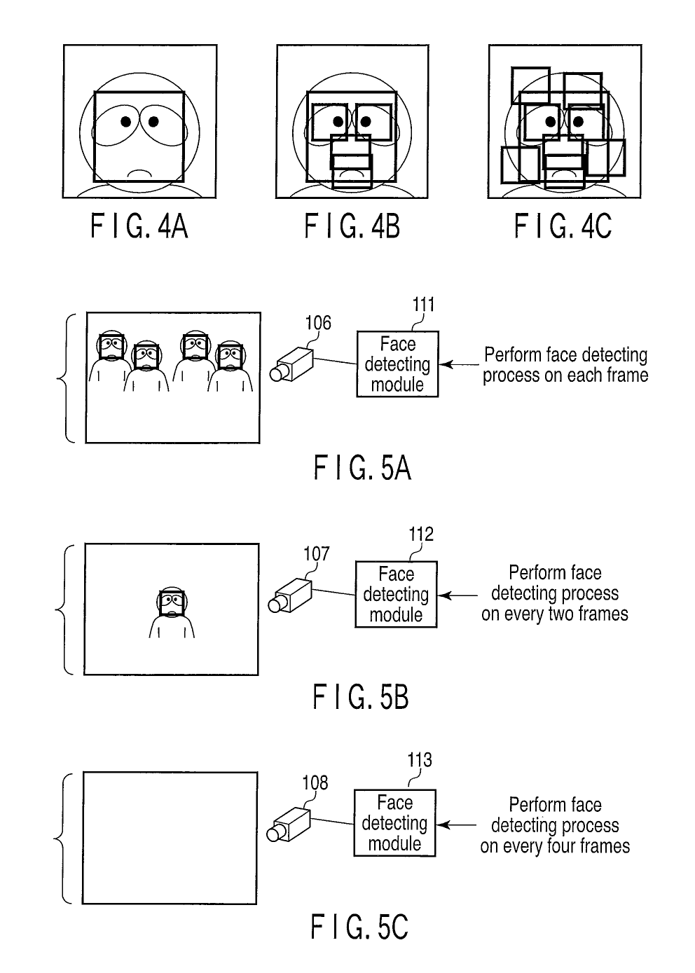

FIGS. 4A, 4B and 4C are diagrams explaining how face regions are extracted from an input image. More specifically, FIG. 4A is a diagram explaining how to extract a few face regions, FIG. 4B is a diagram explaining how to extract more face regions, and FIG. 4C is a diagram explaining how to extract still more face region.

To extract regions from an image for which high priority has been calculated, the processing method control module 120 controls the face detecting module 114, causing the same to extract a few face regions from the input image as shown in FIG. 4A.

To extract regions from an image for which intermediate priority has been calculated, the processing method control module 120 controls the face detecting module 114, causing the same to extract more face regions from the input image as shown in FIG. 4B.

To extract regions from an image for which low priority has been calculated, the processing method control module 120 controls the face detecting module 114, causing the same to extract even more face regions from the input image as shown in FIG. 4C.

The image processing apparatus 100 can, therefore, switch the detecting process from one mode to another, in accordance with the process speed desired.

That is, if the priority calculate is high, the image processing apparatus 100 shortens the process time. For example, the image processing apparatus 100 may change the process parameter to perform the process at high speed, but at low precision. Alternatively, the image processing apparatus 100 may change the process parameter to perform the process, conversely at low speed, but at high precision.

Moreover, the processing method control module 120 may control the face detecting module 114, causing the same to extract face regions, frame by frame, from an image input from a camera 109 for which low priority has been set because the image has no face regions at all.

FIGS. 5A, 5B and 5C are diagrams explaining a face detecting process performed on an image photographed by the camera 109 shown in FIG. 1. More precisely, FIG. 5A is a diagram explaining how to perform the face detecting process on an image of high priority, FIG. 5B is a diagram explaining how to perform the face detecting process on an image of intermediate priority, and FIG. 5C is a diagram explaining how to perform the face detecting process on an image of low priority.

To extract face regions from an image for which high priority has been calculated, the processing method control module 120 performs the face detecting process, frame by frame, as shown in FIG. 5A. That is, the processing method control module 120 sets a high face-detecting frequency for any frames that will be photographed by the camera 109 that has output the image for which high priority has been calculated.

To extract face regions from an image for which intermediate priority has been calculated, the processing method control module 120 performs the face detecting process on every two frames, as shown in FIG. 5B. That is, the processing method control module 120 sets an intermediate face-detecting frequency for any frames that will be photographed by the camera 109 that has output the image for which intermediate priority has been calculated.

To extract face regions from an image for which low priority has been calculated, the processing method control module 120 performs the face detecting process on every four frames, as shown in FIG. 5C. That is, the processing method control module 120 sets a low face-detecting frequency for any frames that will be photographed by the camera 109 that has output the image for which low priority has been calculated. Thus, the image processing apparatus 100 can change the process precision in accordance with the load of processing the image.

The feature extracting module 119 calculates feature values for the respective face regions (or facial regions) the face detecting module 114 has detected. The feature extracting module 119 transmits the feature values to the recognition module 130. That is, the image processing apparatus 100 can predict the load of processing the image and perform the face detecting process, as explained above, thereby to control the number of images the feature extracting module 119 may process. As a result, the entire operating load of the image processing apparatus 100 can be reduced.

In normal operating mode, the face detecting module 114 detects a face region in modules of pixels. If the priority is low, for example, the face detecting module 114 may be configured to extract every fourth pixel in the face detecting process.

Further, the processing method control module 120 may control the feature extracting module 119, causing the same to select resolution that accords with the priority, before extracting features. The processing method control module 120 may control the feature extracting module 119, causing the same to extract features, for example, at low resolution.

Still further, the processing method control module 120 may be configured to control the feature extracting process the feature extracting module 119 performs. The feature extracting module 119 comprises a first feature extracting module configured to extract features from one image, and a second feature extracting module configured to extract features from a plurality of images. The processing method control module 120 controls the feature extracting module 119 such that the first feature extracting module is switched to the second feature extracting module, or vice versa.

For example, the processing method control module 120 causes the second feature extracting module to extract features from an image of low priority, and the first feature extracting module to extract features from an image of high priority. The recognition module 130 performs the recognition process on the basis of the features extracted by the feature extracting module 119.

Moreover, the processing method control module 120 may alter the order in which to subject images to the feature extracting process, so that an image of higher priority may be processed prior to an image of lower priority. Further, the processing method control module 120 may alter the order in which to subject images to similarity calculation, so that an image of higher priority may be recognized prior to an image of lower priority. The image processing apparatus 100 can therefore recognize, without delay, the persons in any image no matter how many persons appear in the image or how fast they are moving in the image.

Further, the processing method control module 120 controls the recognition module 130, causing the same to change, before calculating similarity, the plane number of the subspace in accordance with the priority. The time and precision of the similarity calculation can thereby be balanced. Note that the plane number is data representing the number of vectors that are used in the mutual subspace method in order to calculate similarity. That is, more planes are used to raise the precision of the recognition process, and fewer planes are used to lower the recognition process.

The output module 150 outputs the result of the recognition performed by the recognition module 130, from the image processing apparatus 100. That is, the output module 150 outputs control signals, audio data and image data in accordance with the result of recognition.

The output module 150 outputs, for example, the feature data about the input image and the facial feature data stored in the registered facial-feature control module 140. In this case, the output module 150 receives the feature data about the input data from the recognition module 130, and also the facial feature data having high similarity, which is stored in the registered facial-feature control module 140, and outputs both data items from the image processing apparatus 100. Further, the output module 150 may adds similarity to the features extracted. Still further, the output module 150 may output a control signal for generating an alarm if the similarity exceeds a prescribed value.

As described above, the image processing apparatus 100 of this embodiment sets similarity to each input image. In accordance with the similarity, the processing method control module 120 controls the resolution and frequency at which the face detecting module 114 should extract face regions, and also the number of face regions the face detecting module 114 should extract. Any input image can therefore be processed at a smaller load than otherwise. As a result, the embodiment can provide an apparatus and a method, both capable of processing images in order to accomplish efficient monitoring.

In the embodiment described above, the face detecting module 114 and the feature extracting module 119 operate independently of each other. Nonetheless, the face detecting module 114 may be configured to perform the function of the feature extracting module 119, as well. In this case, the face detecting module 114 not only detects face regions from the input image, but also calculates the feature values for the respective face regions. Alternatively, the recognition module 130 may be configured to perform the function of the feature extracting module 119, as well. If this is the case, the face detecting module 114 transmits the extracted face images to the recognition module 130, and the recognition module 130 calculates the feature values from the face images, recognizing any person appearing in the input image.

An image processing apparatus and an image processing method, both according to a second embodiment, will be described in detail.

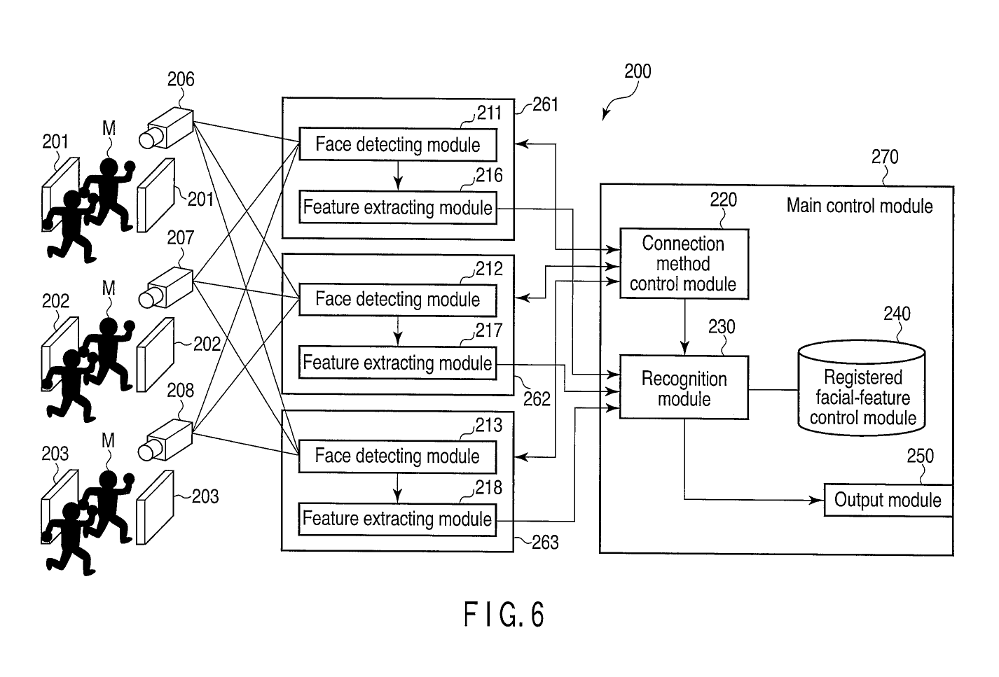

FIG. 6 is a block diagram explaining an exemplary configuration of the image processing apparatus 200 according to the second embodiment.

As shown in FIG. 6, the image processing apparatus 200 comprises sub-control modules 261, 362 and 263 (hereinafter referred to, generally as “sub-control module 264”) and a main control module 270.

The sub-control module 261 comprises a face detecting module 211 and a feature extracting module 216. Similarly, the sub-control module 262 comprises a face detecting module 212 and a feature extracting module 217, and the sub-control module 263 comprises a face detecting module 213 and a feature extracting module 218. Hereinafter, the face detecting modules 211, 212 and 213 will be generally called “face detecting module 214,” and the feature extracting modules 216, 217 and 218 will be generally called “feature extracting module 219.”

The main control module 270 comprises a connection method control module 220, a recognition module 230, a registered facial-feature control module 240, and an output module 250.

The face detecting module 214 performs a face detecting process similar the process the face detecting module 214 does in the first embodiment. The feature extracting module 219 performs a feature extracting process similar to the process the feature extracting module 119 does in the first embodiment. Further, the recognition module 230 performs a recognition process similar to the process the recognition module 130 does in the first embodiment.

As shown in FIG. 6, a camera 206 is installed in passage 201. A camera 207 is installed in passage 202. A camera 208 is installed in passage 203. The cameras 206, 207 and 208 (generally called “camera 209”) are connected to the sub-control module 264. More precisely, the camera 206 is connected to the sub-control modules 261, 262 and 263, the camera 207 to the sub-control modules 261, 262 and 263, and the camera 208 to the sub-control modules 261, 262 and 263.

That is, each camera 209 is connected to a plurality of sub-control modules 264 by HUB or LAN.

The camera 209 is switched, from one to another, under the control of the sub-control modules 264. That is, the camera 209 is so switched by means of an NTSC system, and can be connected to any sub-control modules 264. The camera 209 may be constituted by a network camera. In this case, the sub-control modules 264 designates the IP address of any desired camera 209, thereby to receive images from the camera 209. It does not matter how many cameras 209 are connected to each sub-control module 264.

Each sub-control module 264 comprises, for example, a CPU, a RAM, a ROM and a nonvolatile memory. The CPU is the control module of the sub-control module 26. The CPU functions as means for performing various processes in accordance with the control programs and control data which are stored in the ROM or the nonvolatile memory.

The RAM is a volatile memory that functions working memory for the CPU. That is, the RAM works as storage means for temporarily stores the data the CPU is processing. Further, the RAM temporarily stores the data it has received from an input module. The ROM is a nonvolatile memory that stores control programs and control data.

The nonvolatile memory is constituted by a recording medium in which data can be written and rewritten, such as an EEPROM and an HDD. In the nonvolatile memory, control programs and various data items have been written, which are all necessary for the operation of the image processing apparatus 200.

The sub-control module 264 has an interface configured to receive images from the camera 209. The sub-control module 264 further has an interface configured to receive data from, and transmit data to, the main control module 270.

Like the sub-control module 264, the main control module 270 has a CPU, a RAM, a ROM and a nonvolatile memory. The main control module 270 further has an interface that is configured to receive data from, and transmit data to, the sub-control module 264.

The image processing apparatus 200 according to the present embodiment has a client server configuration, and processes the data received from each sub-control module 264 in order to recognize a specific person from the images photographed by the plurality of cameras 206, 207 and 208. The images of the face regions and the feature values, all detected from the image photographed by each camera 209, are thereby input to the main control module 270. The main control module 270, which functions as server, determines whether the person of any face image detected has been registered or not in the registered facial-feature control module 240.

The connection method control module 220 controls the switching of the sub-control module 264 with respect to the camera 209, in accordance with the result of the face detecting process performed on the image photographed by the camera 209. Here, the connection method control module 220 functions as control module.

The connection method control module 220 performs the same method as the processing method control module 120 does in the first embodiment, and sets priority for the image photographed by each camera 209. That is, in accordance with the priority set to the image, the connection method control module 220 switches the connection between each sub-control module 264 and each camera 209.

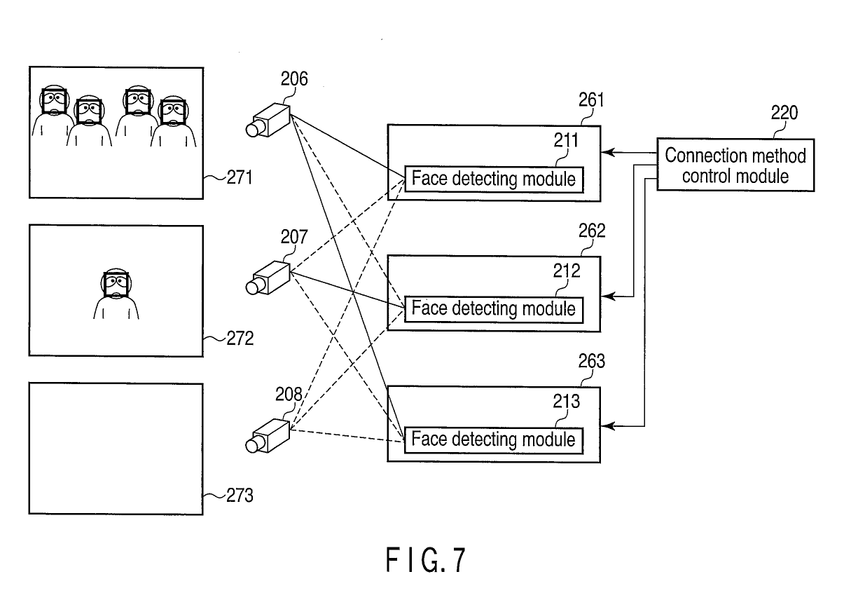

FIG. 7 is a diagram explaining the process that the connection method control module 220 (FIG. 6) performs. FIG. 7 shows three images 271, 272 and 273. The image 271 has been photographed by the camera 206, the image 272 shown in FIG. 7 has been photographed by the camera 207, and the image 273 has been photographed by the camera 208. In the image 271, four face regions are detected. In the image 272, one face region is detected. In the image 273, no face regions are detected.

Therefore, the connection method control module 220 determines that the image 271 photographed by the camera 206 has the highest priority, the image 272 photographed by the camera 207 has the second highest priority, and the image 273 photographed by the camera 208 has the lowest priority.

In this case, the connection method control module 220 controls the method of connecting the camera 209 and sub-control modules 264, in order to input the image photographed by the camera 206 having the highest priority to the sub-control modules 264. In the case of FIG. 7, the connection method control module 220 inputs the image 271 photographed by the camera 206 to the sub-control modules 261 and 263.

In this case, the face detecting modules 211 of the sub-control module 261 and the face detecting modules 213 of the sub-control module 263 alternately process an image, frame by frame. The face detecting modules 211 of the sub-control module 261 and the face detecting modules 213 of the sub-control module 263 may be configured to process the halves of an image, respectively.

The connection method control module 220 controls the connection so that the image output from the camera 208 that has detected no face regions in the preceding frame may be input at prescribed intervals to the sub-control module 264. The sub-control module 264 detects face regions in, for example, one of every four frames of the image photographed by the camera 208.

As has been described, the image processing apparatus 200 according to the present embodiment sets priority to each image input from any camera. In the image processing apparatus 200, the connection between the camera 209 and the sub-control module 264 is controlled in accordance with the priority set to the image. Any image that requires a large processing load is input to a plurality of sub-control modules 264, which process the regions of the image. Thus, this embodiment can provide an apparatus and a method, both capable of processing images in order to accomplish efficient monitoring.

The second embodiment has three sub-control modules 264. Nonetheless, the second embodiment can operate well if it has at least two sub-control modules 264.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a plurality of image input modules configured to input images;
a detection module configured to detect object regions from an image input by any image input module;
a feature extracting module configured to extract feature values from any object regions detected by the detecting module; and
a control module configured to control processes the detection module and feature extracting module perform on the images input by the plurality of image input modules, in accordance with the result of detection performed by the detection module.

2. The image processing apparatus according to claim 1, wherein the detection module detects face regions from the image input by any image input module, and the control module sets priority for each image input module in accordance with the result of detection and controls, in accordance with the priority set, the processes the detection module and feature extracting module perform on the images input by the plurality of image input modules.

3. The image processing apparatus according to claim 2, wherein the control module comprises a processing method control module configured to control, in accordance with the priority set, methods in which the detection module and feature extracting module perform on the images input by the plurality of image input modules.

4. The image processing apparatus according to claim 2, wherein the detection module comprises a plurality of detectors, and the control module comprises a connection method control module configured to control, in accordance with the priority set, connection of the plurality of image input modules to the plurality of detectors.

5. The image processing apparatus according to claim 3, wherein the processing method control module sets the priority in accordance with a number of face regions detected by the detection module.

6. The image processing apparatus according to claim 3, wherein the processing method control module sets the priority in accordance with positions of face regions detected by the detection module.

7. The image processing apparatus according to claim 3, wherein the processing method control module sets the priority in accordance with speeds at which face regions detected by the detection module move frame by frame.

8. The image processing apparatus according to claim 3, wherein the processing method control module determines classifications of persons appearing in the face regions from feature values of the face regions detected by the detection module, and sets the priority in accordance with the classifications s so determined.

9. The image processing apparatus according to claim 3, wherein the detection module detects regions changing from frame to frame, from the image input by the input module, and the processing method control module sets the priority in accordance with sizes of the regions detected by the detection module.

10. The image processing apparatus according to claim 3, wherein the detection module detects regions changing from frame to frame, from the image input by the input module, and the processing method control module sets the priority in accordance with positions of the regions detected by the detection module.

11. The image processing apparatus according to claim 3, wherein the processing method control module controls, in resolution, the images of the face regions detected by the detection module in accordance with the priority set.

12. The image processing apparatus according to claim 3, wherein the detection module detects face parts as face regions, and the processing method control module controls a number of face parts detected by the detection module, in accordance with the priority set.

13. The image processing apparatus according to claim 3, wherein the processing method control module controls, in accordance with the priority set, a frequency at which the detection module should detect face regions.

14. The image processing apparatus according to claim 3, wherein the feature extracting module comprises a first extracting module configured to extract a feature value form an image and a second extracting module configured to extract features values from a plurality of images; and the processing method control module switches the first extracting module to the second extracting module, or vice versa, in accordance with the priority set.

15. The image processing apparatus according to claim 4, wherein the connection method control module configured to control the connection, thereby to input images photographed by of the image input modules of high priority, to the plurality of detectors.

16. The image processing apparatus according to claim 2, further comprising:
a registered facial-feature storage module storing facial feature data; and
a recognition module configured to compare the feature values extracted by the feature extracting module with the facial feature data stored in the registered facial-feature storage module, thereby to determine whether the person in any face regions has been registered.

17. An image processing method for use in an image processing apparatus having a plurality of image input modules configured to input images, the method comprising:
detecting object regions from an image input by any image input module;
extracting feature values from any object regions detected; and
controlling a process of detecting the image input by any image input module and a process of extracting the feature vales from the object region, in accordance with the result of detecting the object regions.

18. The image processing method according to claim 17, wherein face regions are detected from the image input by any image input module, priority is set for each image input, in accordance with the result of detecting the object regions, and the process of detecting each image input by the image input modules and the process of extracting the feature vales from the image are controlled in accordance with the priority set.
